(19) United States
(12) Patent Application Publication
(10) Pub. No.: US 2025/0109678 A1
(43) Pub. Date: Apr. 3, 2025

(54) DISCRETE PERFORATING DEVICE

(71) Applicant: Schlumberger Technology Corporation, Sugar Land, TX (US)

(72) Inventors: Saad Omar, Sharon, MA (US); Lin Liang, Cambridge, MA (US)

(21) Appl. No.: 18/899,776

(22) Filed: Sep. 27, 2024

Related U.S. Application Data
(60) Provisional application No. 63/586,115, filed on Sep. 28, 2023.

(51) Int. Cl. E21B 47/003; E21B 47/026; E21B 49/08

(52) U.S. Cl. CPC E21B 47/003; E21B 47/026; E21B 49/087; E21B 2200/20

(57) ABSTRACT

The present disclosure relates to a method that includes receiving ultra-deep azimuthal resistivity (UDAR) measurements from a downhole tool within a geological formation. The method also includes determining a data processing window based on a relative location of a transmitter of the downhole tool with respect to a location of one or more components of the downhole tool. Further, the method includes performing a three-dimensional (3D) inversion of the UDAR measurements based on the relative location of the transmitter. Further still, the method includes generating an anisotropic resistivity distribution and relative formation dip output based on the 3D inversion.

### CROSS REFERENCE TO OTHER APPLICATION

This application claims priority to and the benefit of U.S. Provisional Patent Application Ser. No. 63/586,115, entitled “Ultra-Deep Azimuthal Resistivity Measurements for Formation Evaluation”, filed Sep. 28, 2023, which is hereby incorporated by reference in its entirety for all purposes.

### BACKGROUND

The present disclosure generally relates to systems and methods for discrete perforating devices.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admission of prior art.

Ultra-Deep Azimuthal Resistivity (UDAR) measurements provide full three-dimensional (3D) volumetric sensitivity to the surrounding formation and are routinely used for strategic geosteering, reservoir navigation, characterization, and real-time drilling decision-making based on inverted resistivity profile. Existing 3D processing employ approximate computational domain discretization for modeling and inversion, leading to extremely smoothened formation mapping with artifacts appearing away from borehole, thereby compromising higher resolution and superior accuracy of the underlying 3D UDAR measurements. High resolution and accurate 3D reservoir mapping is critical for delivering precise drilling performance to increase asset recovery, improve wellbore quality, and reduce overall well construction costs, as well as optimal production.

### BRIEF DESCRIPTION

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In some embodiments, the present disclosure relates to a method. The method includes receiving ultra-deep azimuthal resistivity (UDAR) measurements from a downhole tool within a geological formation. The method also includes determining a data processing window based on a relative location of a transmitter of the downhole tool with respect to a location of one or more components of the downhole tool. Further, the method includes performing a three-dimensional (3D) inversion of the UDAR measurements based on the relative location of the transmitter. Further still, the method includes generating an anisotropic resistivity distribution output based on the 3D inversion.

In some embodiments, the present disclosure relates to a tangible, non-transitory, computer-readable medium configured to store instructions executable by processing circuitry. The instructions comprise instructions to cause the processing circuitry to perform operations comprising receiving ultra-deep azimuthal resistivity (UDAR) measurements from a downhole tool within a geological formation, determining a data processing window based on a relative location of a transmitter of the downhole tool with respect to a location of one or more components of the downhole tool, performing a three-dimensional (3D) inversion of the UDAR measurements based on the relative location of the transmitter, and generating an anisotropic resistivity distribution output based on the 3D inversion.

In some embodiments, the present disclosure relates to a system. The system includes an electromagnetic downhole tool configured to generate electromagnetic measurements associated with a volume within a geological formation. The system also includes a data processing system communicatively coupled to the electromagnetic downhole tool. The data processing system comprises one or more processors. The data processing system is configured to receive ultra-deep azimuthal resistivity (UDAR) measurements from a downhole tool within a geological formation. The data processing system is also configured to determine a data processing window based on a relative location of a transmitter of the downhole tool with respect to a location of one or more components of the downhole tool. Further, the data processing system is configured to perform a three-dimensional (3D) inversion of the UDAR measurements based on the relative location of the transmitter. Further still, the data processing system is configured to generate an anisotropic resistivity distribution output based on the 3D inversion.

Various refinements of the features noted above may be undertaken in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended to familiarize the reader with certain aspects and contexts of embodiments of the present disclosure without limitation to the claimed subject matter.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a first example of an electromagnetic well-logging system, in accordance with aspects of the present disclosure;

FIG. 2 is a second example of an electromagnetic well-logging system, in accordance with aspects of the present disclosure;

FIG. 3 is a flowchart of an example method for performing a three-dimensional (3D) inversion of electromagnetic measurements, in accordance with aspects of the present disclosure;

FIG. 4 illustrates a 3D volume definition that may be utilized in the method of FIG. 3, in accordance with aspects of the present disclosure

FIG. 5 is an illustration of grid discretization that may be utilized in the method of FIG. 3, in accordance with aspects of the present disclosure;

FIG. 6 illustrates a visualization of a model, in accordance with aspects of the present disclosure;

FIG. 7A illustrates a 3D resistivity model and a 3D voxel-based inversion result, in accordance with aspects of the present disclosure;

FIG. 7B illustrates inversion results based on the model of FIG. 6, in accordance with aspects of the present disclosure;

FIG. 8 illustrates inversion results based on a hand-brake turn model, in accordance with aspects of the present disclosure;

FIG. 9 illustrates inversion results that provide look-ahead capabilities, in accordance with aspects of the present disclosure;

FIG. 10 illustrates a visualization of a model, in accordance with aspects of the present disclosure;

FIG. 11 illustrates a visualization of 3D inversion results based on the model of FIG. 10, in accordance with aspects of the present disclosure;

FIG. 12 illustrates a visualization of a model, in accordance with aspects of the present disclosure; and

FIG. 13 illustrates a visualization of 3D inversion results based on the model of FIG. 12, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the terms “connect,” “connection,” “connected,” “in connection with,” and “connecting” are used to mean “in direct connection with” or “in connection with via one or more elements”; and the term “set” is used to mean “one element” or “more than one element.” Further, the terms “couple,” “coupling,” “coupled,” “coupled together,” and “coupled with” are used to mean “directly coupled together” or “coupled together via one or more elements.” As used herein, the terms “up” and “down,” “uphole” and “downhole”, “upper” and “lower,” “top” and “bottom,” and other like terms indicating relative positions to a given point or element are utilized to more clearly describe some elements. Commonly, these terms relate to a reference point as the surface from which drilling operations are initiated as being the top (e.g., uphole or upper) point and the total depth along the drilling axis being the lowest (e.g., downhole or lower) point, whether the well (e.g., wellbore, borehole) is vertical, horizontal or slanted relative to the surface.

In addition, as used herein, the terms “real time”, “real-time”, or “substantially real time” may be used interchangeably and are intended to described operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “automatic” and “automated” are intended to describe operations that are performed or caused to be performed, for example, by a data processing system (i.e., solely by the data processing system, without human intervention). In addition, as used herein, the term “approximately equal to” or “substantially” may be used to mean values that are relatively close to each other (e.g., within 5%, within 2%, within 1%, within 0.5%, or even closer, of each other).

The present disclosure relates to voxel-based processing techniques for obtaining, in substantially real-time, a high resolution three-dimensional (3D) resistivity profile that may represent arbitrarily heterogeneous formations, anisotropic formations, or otherwise irregular shaped or distributed formations. The disclosed techniques include receiving electromagnetic measurements (e.g., ultra-deep azimuthal resistivity (UDAR) measurements) from a downhole tool within a geological formation. The techniques also include determining a data processing window based on a relative location of a transmitter of the downhole tool with respect to a location of one or more components of the downhole tool. Further, the techniques include performing a three-dimensional (3D) inversion of the UDAR measurements based on the relative location of the transmitter. Further still, the techniques include generating an anisotropic resistivity distribution output based on the 3D inversion. In some embodiments, the disclosed techniques may utilize exact full 3D EM solver with no approximation both while modeling and during inversion. In this way, the disclosed techniques provide for an accurate and high-resolution processing workflow that may provide real-time (transmitter-referenced) inversion of UDAR measurements through an exact full 3D EM simulator while allowing arbitrarily variations in any dimensions via balanced L1-regularization to provide anisotropic resistivity distribution with optional structurally similar constrained on vertical resistivity. As such, the disclosed techniques provide an improvement as compared to conventional approaches which may, for example, utilize approximations and smooth (L2) regularization that leads to smoothened formation mapping with artifacts appearing away from borehole. Technical effects of the disclosed techniques include high accuracy and resolution in real-time.

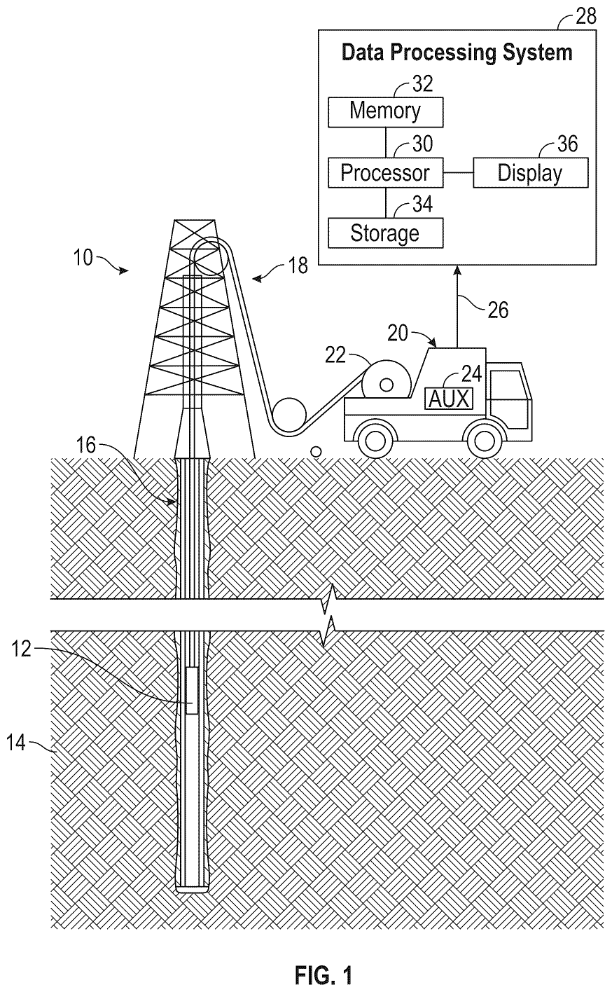

With this in mind, FIG. 1 illustrates an electromagnetic well-logging system 10 that may employ the systems and methods of this disclosure. The electromagnetic well-logging system 10 may be used to convey an electromagnetic well-logging tool 12 through a geological formation 14 via a wellbore 16. The electromagnetic well-logging tool 12 may be conveyed on a cable 18 via a logging winch system 20. Although the logging winch system 20 is schematically shown in FIG. 1 as a mobile logging winch system carried by a truck, the logging winch system 20 may be substantially fixed (e.g., a long-term installation that is substantially permanent or modular). Any suitable cable 18 for well logging may be used. The cable 18 may be spooled and unspooled on a drum 22 and an auxiliary power source 24 may provide energy to the logging winch system 20 and/or the electromagnetic well-logging tool 12.

Moreover, although the electromagnetic well-logging tool 12 is described as a wireline downhole tool, it should be appreciated that any suitable conveyance may be used. For example, the electromagnetic well-logging tool 12 may instead be conveyed as a logging-while-drilling (LWD) tool as part of a bottom hole assembly (BHA) of a drill string, conveyed on a slickline or via coiled tubing, and so forth. For the purposes of this disclosure, the electromagnetic well-logging tool 12 may be any suitable measurement tool that obtains electromagnetic logging measurements through depths of the wellbore 16.

Many types of electromagnetic well-logging tools 12 may obtain electromagnetic logging measurements in the wellbore 16. The electromagnetic well-logging tool 12 may provide electromagnetic logging measurements 26 to a data processing system 28 via any suitable telemetry (e.g., via electrical signals pulsed through the geological formation 14 or via mud pulse telemetry). The data processing system 28 may process the electromagnetic logging measurements 26 to derive an anisotropic resistivity distribution and formation dip (angle) of the geological formation 14 around the wellbore 16.

To this end, the data processing system 28, thus, may be any electronic data processing system that can be used to carry out the systems and methods of this disclosure. For example, the data processing system 28 may include a processor 30, which may execute instructions stored in memory 32 and/or storage 34. As such, the memory 32 and/or the storage 34 of the data processing system 28 may be any suitable article of manufacture that can store the instructions. The memory 32 and/or the storage 34 may be ROM memory, random-access memory (RAM), flash memory, an optical storage medium, or a hard disk drive, to name a few examples. A display 36, which may be any suitable electronic display, may provide a visualization, a well log, or other indication of properties in the geological formation 14 or the wellbore 16 using the electromagnetic logging measurements 26.

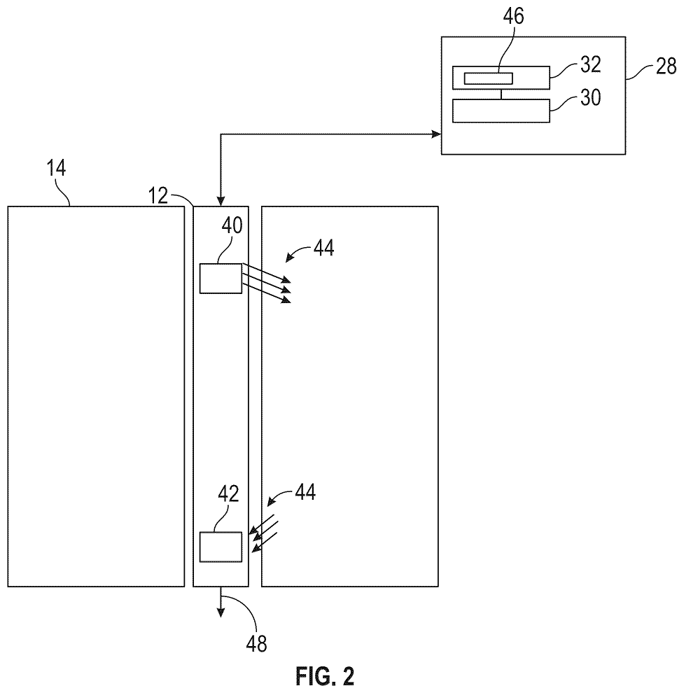

FIG. 2 illustrates an example of an electromagnetic well-logging tool 12 (e.g., electromagnetic downhole tool) that may acquire electromagnetic measurements (e.g., resistivity measurements, UDAR measurements). The illustrated embodiment of the electromagnetic well-logging tool 12 includes one or more receivers 42 and a transmitter 40. Although the transmitter 40 is shown as being uphole of the receiver 42, it should be noted that the transmitter 40 may be downhole of one or more receivers 42 of the electromagnetic well-logging tool 12 or at the same location as the receiver (co-located i.e. wound on the same core as the receiver). While only one receiver 42 and one transmitter 40 are shown, it should be noted that the number of transmitters 40 and receivers 42 is not a limit on the scope of the present disclosure. Moreover, in an embodiment of the electromagnetic well-logging tool 12 that includes multiple receivers 42, each receiver 42 may be disposed one or more positions along the electromagnetic well-logging tool 12. For example, the electromagnetic well-logging tool 12 may include a first receiver 42 within a first location that is uphole of the transmitter 40, and the electromagnetic well-logging tool 12 may include a second receiver 42 within a second location that is uphole of the first receiver 42. Generally speaking, the transmitter 40 induces electric eddy currents to produce electromagnetic waves 44 having a set of frequencies in a direction of the magnetic dipole moment of the transmitter 40. The electromagnetic waves 44 that interact with the geological formation 14 are subsequently received by the receiver 42 to generate electromagnetic measurements. The electromagnetic well-logging tool 12 may be a logging-while-drilling (LWD) tool capable of drilling and obtaining, measuring, or otherwise acquiring electromagnetic measurements using the receiver 42 and the transmitter 40.

As shown in FIG. 2, the illustrated embodiment of the electromagnetic well-logging tool 12 is communicatively coupled to the data processing system 28, which includes a model 46 (e.g., a 3D voxel-based model) stored in the memory 32. As discussed in further detail below, the model 46 may be utilized by the processor 30 of the data processing system 28 to determine the tool response using a 3D electromagnetic (EM) solver.

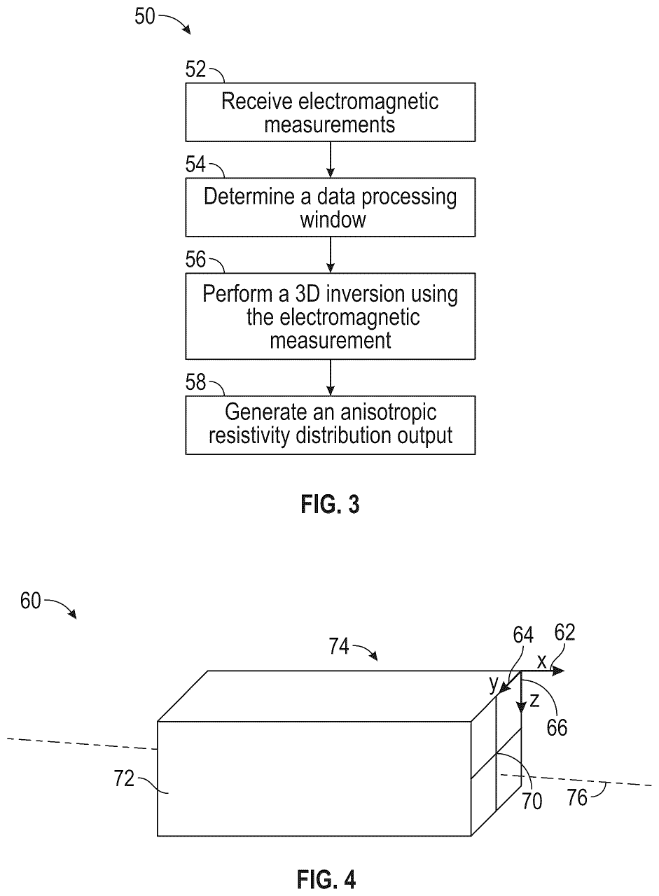

As described above, the disclosed techniques include performing a 3D voxel-based inversion to generate an anisotropic resistivity distribution and visualization output related to a subterranean region. To illustrate this, FIG. 3 illustrates a flow diagram of an example process 50 for determining an anisotropic resistivity distribution output, such as a visualization representing a volume of a downhole region, an alert, or otherwise. Although the process 50 is described as being performed by the processor 30 of the data processing system 28, it should be noted that any suitable processor (e.g. or one or more processors) may perform the process 50. Although described in a particular order, it should be noted that certain steps of the process 50 may be performed before other steps.

At block 52, the processor 30 receives electromagnetic measurements (e.g., resistivity measurements, UDAR measurements) obtained by the electromagnetic well-logging tool 12. In some embodiments, the electromagnetic measurements may include data obtained by multiple receivers 42 disposed along the electromagnetic well-logging tool 12 as generally described above with reference to FIG. 2. The electromagnetic measurements correspond to a 3D volume within the geological formation 14. As such, the electromagnetic measurements may correspond to voxels representing sub-volumes (e.g., subsets of the 3D volume) within the geological formation 14.

At block 54, the processor 30 determines a data processing window based on a relative location of the transmitter 40 with respect to a location of one or more components (e.g., a drill bit, a receiver 42, or other components of the electromagnetic well-logging tool 12). In some embodiments, the processor 30 may determine a data processing window such that each voxel corresponds to a fraction of the distance between the transmitter and a component of the electromagnetic well-logging tool 12. For example, the data processing window may correspond to at least 1.5 times the longest distance between the transmitter 40 and receivers 42. It should be noted that, the electromagnetic well-logging tool 12 may be a modular component. That is, the relative distance between the transmitter 40 and the one or more components of the electromagnetic well-logging tool 12 may vary for different jobs. As such, the processor 30 may determine the relative distance, such as by accessing reference information indicating the relative distance that is stored in a memory.

At block 56, the processor 30 performs a 3D inversion using the electromagnetic measurements based on the location of the transmitter 40. The 3D inversion may be a 3D voxel-based inversion as described herein. The processor 30 may perform the 3D inversion using the model 46 by minimizing a cost function based on the tool response (e.g., the electromagnetic measurements obtained at block 52). An example cost function is shown and described in more detail with reference to Eqn. 13.

In some embodiments, the processor 30 may perform the 3D inversion using an initial model of the geological formation 14. In such embodiments, the processor 30 may update the initial model (e.g., the model 46) using the electromagnetic measurements until the model converges (e.g., the model change is within a threshold range, such as less than or equal to 10%, 5%, 2%, 1%, 0.5%, 0.1%), thereby generating an updated model. A non-limiting example is described below with reference to Eqns. 13-15.

At block 58, the processor 30 generates an anisotropic resistivity distribution output, such as a visualization, the updated model, an alert, or otherwise. The anisotropic resistivity distribution output may be data that indicates the anisotropic resistivity distribution within the volume where the downhole well-logging tool 12 is obtaining the electromagnetic measurements. In some embodiments, the processor 30 may determine a formation dip based on the anisotropic resistivity distribution. In some embodiments, the processor 30 may generate or update an initial model using the anisotropic resistivity distribution. In some embodiments, the processor 30 may determine a saturation of the volume using the anisotropic resistivity distribution. Accordingly, the anisotropic resistivity distribution output may be utilized to inform oil and gas decisions, such as where to drill. In some embodiments, the processor 30 may cause a visualization of the 3D volume measurement by the electromagnetic well-logging tool 12 to display on a suitable display (e.g., the display 36), thereby aiding a user in monitoring the operations (e.g., drilling) performed by the electromagnetic well-logging tool 12). In some embodiments, the processor 30 may generate alert that indicates that it may be desirable to perform additional measurements to refine the updated model. Accordingly, the process 50 provides techniques for generating an anisotropic resistivity distribution output, such as a visualization, data indicating a formation dip, a saturation, and the like, in substantially real-time.

As described with reference to block 56 of FIG. 3, the processor 30 may perform a 3D inversion using the electromagnetic measurements and the initial model. With this in mind, FIG. 4 is an illustration of 3D volume definition 60 of the 3D inversion, in accordance with aspects of the present disclosure. To facilitate the discussion below, FIG. 4 includes an x-axis 62, a y-axis 64, and a z-axis 66. Table 1 shows parameters related to the 3D volume (e.g., 3D voxel formation).

TABLE 1
3D volume parameters

| | Variable name | |
|---|---|---|
| Matlab definition | used in report | Dimensions |
| Formation.x | x_{f} | Vector length m |
| Formation.y | y_{f} | Vector length n |
| Formation.z | z_{f} | Vector length l |
| Formation.rh | Rh | Matrix size nxmxl |
| Formation.anis | anis | Matrix size nxmxl |

where x_{f}, y_{f} and z_{f} define the dimensions and voxel sizes of the 3D volume around the wellbore. The z-axis 66 and x-axis 62 of 3D volume align with the TVD and THL-axis of the trajectory and the y-axis 64 completes the coordinate system. It is assumed that the trajectory is the y=0 plane (e.g., that the trajectory azimuth is not changing within the data window). Rh and anis are the horizontal resistivity and anisotropy values of the voxel grid defined by x_{f}, y_{f} and z_{f}. The anisotropy direction is along the z-axis. The terms x_{f}, y_{f} and z_{f} are vectors of the voxel boundary positions and define a finite volume, the outermost voxels do not extend to infinity. At least in some instance, only the (n−1)×(m−1)×(l−1) resistivity and anisotropy values are utilized to fill the voxel domain so the last entries of Rh and anis may be ignored. The voxel volume is embedded in homogeneous background with the average resistivity of all voxels. In some instances, the processor 30 may receive scalar variables to the formation definition, such as the formation dip and azimuth. These two angles define the rotation of the anisotropy direction inside the voxel (the voxel grid remains aligned with THL-TVD).

The 3D modeling code allows a general anisotropy definition, all six elements of the conductivity tensor may be defined independently:

$$σ = [ \begin{matrix}{σ}_{xx} & {σ}_{xy} & {σ}_{xz} \\ {σ}_{xy} & {σ}_{yy} & {σ}_{yz} \\ {σ}_{xz} & {σ}_{yz} & {σ}_{zz}\end{matrix} ] \qquad ( 1 )$$

In some instances, the anisotropy aligns with the z-axis and the conductivity tensor (e.g., as shown in eqn. 1) simplifies to:

$$σ = [ \begin{matrix}{σ}_{h} & 0 & 0 \\ 0 & {σ}_{h} & 0 \\ 0 & 0 & {σ}_{v}\end{matrix} ] \qquad ( 2 )$$

with the vertical and horizontal conductivity σᵥ and σₕ.

The anisotropy description was generalized, so the 3D voxel inversion can run with an arbitrary alignment of the vertical and horizontal conductivity, defined by two rotation angles, the anisotropy dip α as a rotation around the y-axis and the anisotropy azimuth β as rotation around the z-axis. The rotation matrices for the two rotations are:

$${R}_{α} = [ \begin{matrix}cos α & 0 & sin α \\ 0 & 1 & 0 \\ - sin α & 0 & cos α\end{matrix} ] \qquad ( 3 )$$

$${R}_{β} = [ \begin{matrix}cos β & sin β & 0 \\ - sin β & cos β & 0 \\ 0 & 0 & 1\end{matrix} ] \qquad ( 4 )$$

and the transformation of the conductivities follows as:

$$σ = {R}_{β}^{T} {R}_{α}^{T} [ \begin{matrix}{σ}_{h} & 0 & 0 \\ 0 & {σ}_{h} & 0 \\ 0 & 0 & {σ}_{v}\end{matrix} ] {R}_{α} {R}_{β} \qquad ( 5 )$$

Accordingly, eqn. 5 provides the following elements of the conductivity tensor:

$${σ}_{x x} = {cos}^{2} α \cdot {cos}^{2} β \cdot {σ}_{h} + {sin}^{2} β \cdot {σ}_{h} + {sin}^{2} α \cdot {cos}^{2} β \cdot {σ}_{v} , \qquad ( 6 )$$

$${σ}_{x y} = {cos}^{2} α \cdot cos β \cdot sin β \cdot {σ}_{h} - cos β \cdot sin β \cdot {σ}_{h} + {sin}^{2} α \cdot cos β \cdot sin β \cdot {σ}_{v} , \qquad ( 7 )$$

$${σ}_{x z} = cos α \cdot sin α \cdot cos β \cdot {σ}_{h} - sin α \cdot cos α \cdot cos β \cdot {σ}_{v} , \qquad ( 8 )$$

$${σ}_{y y} = {cos}^{2} α \cdot {sin}^{2} β \cdot {σ}_{h} + {cos}^{2} β \cdot {σ}_{h} + {sin}^{2} α \cdot {sin}^{2} β \cdot {σ}_{v} , \qquad ( 9 )$$

$${σ}_{z z} = {sin}^{2} α \cdot {σ}_{h} + {cos}^{2} α \cdot {σ}_{v} \qquad ( 10 )$$

$${σ}_{y z} = cos α \cdot sin α \cdot sin β \cdot {σ}_{h} - sin α \cdot cos α \cdot sin β \cdot {σ}_{v} \qquad ( 11 )$$

In addition to the measured voltage V at the receiver antennas, the 3D modeling code also outputs the derivative of the voltage with respect to the six conductivity tensor elements σₓₓ, σ_{xy}, σ_{xz}, σ_{yy}, σ_{zz} and σ_{yz}. However, σₕ, σᵥ, α and β are inverted, so the derivatives with respect to σₕ, σᵥ, α and β may be utilized. They can be found with the chain rule:

$$\frac{\partial V}{\partial x} = \frac{\partial V}{\partial {σ}_{x x}} \cdot \frac{\partial {σ}_{xx}}{\partial x} + \frac{\partial V}{\partial {σ}_{x y}} \cdot \frac{\partial {σ}_{x y}}{\partial x} + \frac{\partial V}{\partial {σ}_{x z}} \cdot \frac{\partial {σ}_{x z}}{\partial x} + \frac{\partial V}{\partial {σ}_{y y}} \cdot \frac{\partial {σ}_{y y}}{\partial x} + \frac{\partial V}{\partial {σ}_{y z}} \cdot \frac{\partial {σ}_{y z}}{\partial x} + \frac{\partial V}{\partial {σ}_{z z}} \cdot \frac{\partial {σ}_{z z}}{\partial x} \qquad ( 12 )$$

where V is the measured voltage and x is a placeholder for either σₕ, σₕ, α or β. The derivatives with respect to σₕ and σᵥ, are then converted to derivatives with respect to the logarithm of Rh and Rv using the chain rule. At last, the derivatives of the voltages V are converted to derivatives of the measurement channels m(V) with the finite difference approximation, the measurement generation is called for both V and

$$V + Δ \cdot \frac{\partial V}{\partial x}$$

and the first derivative of the channel response m is approximated with

$$\frac{\partial m}{\partial x} \approx \frac{m ( V + Δ \cdot \frac{\partial V}{\partial x} ) - m ( V )}{Δ} .$$

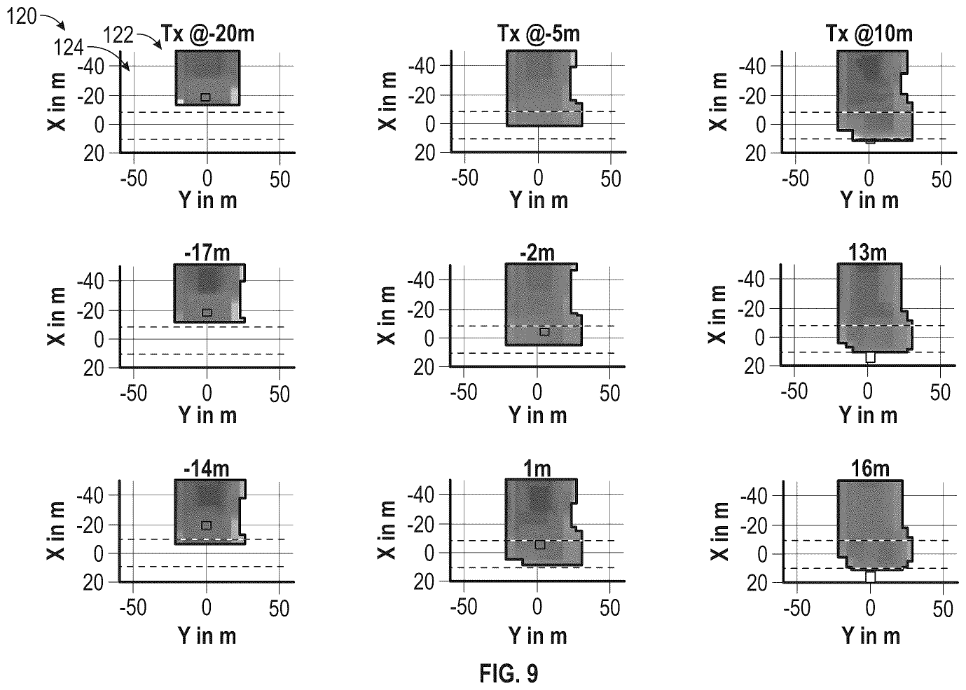

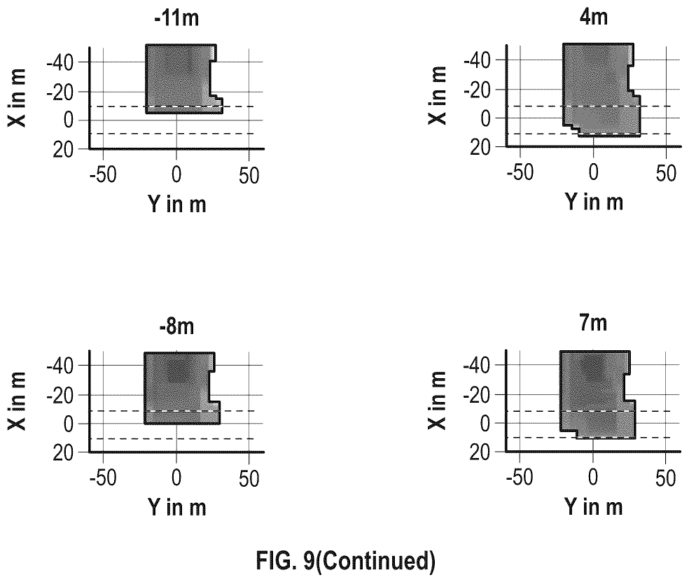

In the disclosed workflow, all measurements may be processed with a common reference point (e.g. tool transmitter 40) as acquired in real-time. The forward modeling code reference point is also adjusted to process data in real-time. It is presently recognized that, Tx-based referencing provides not only practical look-around capabilities but also look-ahead capabilities ahead of the drilling bit in real-time, as shown in FIG. 9.

In some embodiments, the gradient along all three dimensions of the voxel volume may be regularized equally to provide unbiased variation in any spatial dimension dictated only by the measurement sensitivity. This may preserve accuracy as well as true high resolution of the measurement set. In some embodiments, a full 3D EM solver, capable of exactly modeling arbitrary heterogeneity and anisotropy, is used in the inversion loop to substantially match the tool measurements.

Both horizontal and vertical resistivities as well as dip and azimuth can be inverted. The logarithm of the horizontal and vertical resistivity is inverted. Inverting for Rh-Rv instead of Rh-anis may not change the Jacobian matrix (if the logarithm of both is inverted), however it changes the regularization term.

The vertical resistivity can optionally be regularized to have the same structural profile as the horizontal resistivity by turning on the ‘structural similarity regularization’ flag.

Any combination (single, two or three receivers) of 3D Ultra-Deep Azimuthal Resistivity (UDAR) measurement channels can be inverted and optionally, if available, shallow resistivity channels can also be inverted together.

The workflow is robust enough to handle arbitrary initial guesses. In addition to homogeneous (i.e. 0D, Rh=2; Rv=4) and 1D (from 1D inversion) initial models, solutions of both the 2D deep azimuthal inversion and the 2D curtain section inversion can also be used as an initial model (guess) for the 3D inversions. In some embodiments, a data window of 1.5 times the longest spacing is used to accurately reconstruct the 3D volume around the wellbore. This reduces both the number of voxel and the number of measurement points.

In some embodiments, the processor 30 may utilize a certain subset of electromagnetic measurements to perform the 3D inversion. For example, the processor 30 may utilize single receiver and single frequency (apparent resistivity or raw) data based on the spacing (e.g., the distance between) the transmitter 40 and receiver 42. As one specific example, the processor 30 may utilize one data point obtained at a rate of 1/10 or less, 1/12 or less, 1/14 or less of the spacing between the transmitter 40 and the receiver 42.

Absolute values are used for the measurement weight W_{d} of the inversion, 0.25 dB for the attenuation and 1.5° for the phase. Contrary to relative weighting, all channels may be treated equally in the inversion.

### Space Discretization

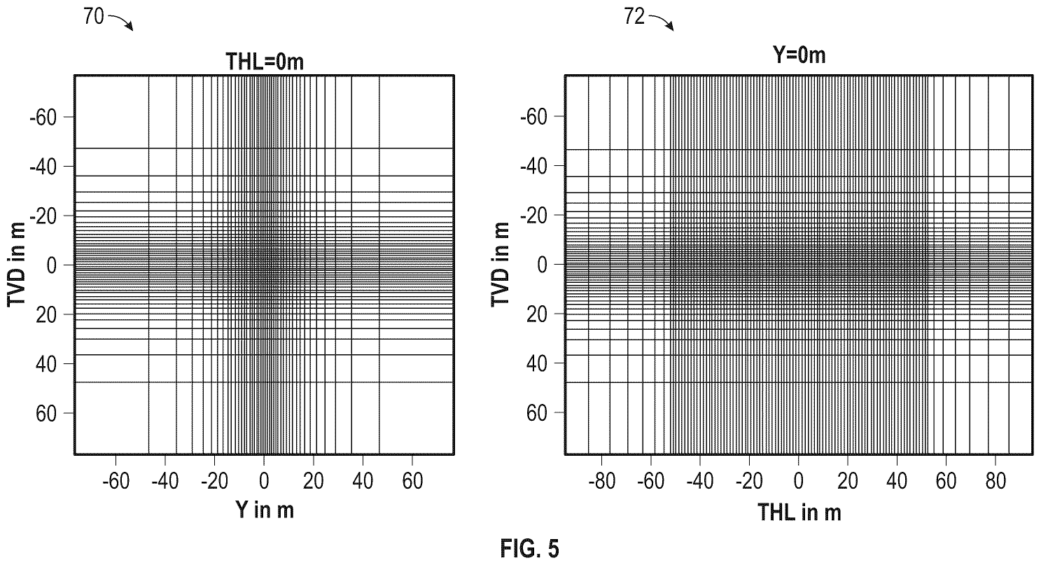

Along the drilling direction, the processor 30 may utilize a data window (e.g., of the electromagnetic measurements) that is at least 1.5, 1.6, 1.7, 1.8, 1.9, 2.0, or greater, times the longest antenna (e.g., receiver antenna) spacing during the 3D inversion. The 3D space may be discretized up to two times the longest spacing away from the trajectory in all three dimensions to cover the whole space the tool is sensitive to. This leads to a discretization in transverse (yz-)direction with the voxel size increasing exponentially along y- and z-direction. Along drilling (x-)direction, the space crossed by the transmitter or receiver antennas is discretized uniformly with a voxel width of one tenth of the shortest spacing (if possible). The space ahead and behind the antennas is padded with voxels of exponentially increasing width. A sample discretization grid for a common BHA setup with antenna spacings of 12 m and 40 m is shown in FIG. 5. More specifically, The 3D mesh/grid generated for a volume shown in FIG. 4 can be projected along x-direction as shown in the left sub figure and along y-direction as shown in the right sub figure. Referring to FIG. 4, the grid 70 corresponds to a plane formed by vectors along the axis 66 and axis 64. The grid 72 corresponds to a plane formed by vectors along the axis 62 and axis 66. This is generally illustrated in the diagram 74 of the volume corresponding to the super-set of the region of the sensitivity of electromagnetic measurements as the downhole well-logging tool 12 moves along the direction 76.

Gauss-Newton algorithm: The number of model parameters can be 300,000 or more and the number of measurements can be around 10,000, so it is desirable for the Gauss-Newton algorithm to be memory and runtime efficient. To estimate the 3D anisotropic resistivity distribution in a cube near wellbore, we minimize the following cost function:

$$C ( x ) = \frac{1}{2} {‖ {W}_{d} \cdot ( f ( x ) - m ) ‖}^{2} + \frac{1}{2} λ \cdot {ϕ}_{G} ( {W}_{x} \cdot x ) \qquad ( 13 )$$

where the Jacobian matrix J contains the first derivatives (sensitivities) of the simulated responses with respect to model parameters x, computed using the adjoint variable technique. The model update Δ“x” can then be found by minimizing the linearized cost function:

$${C}_{l i n} ( Δ x ) = \frac{1}{2} {‖ {W}_{d} \cdot ( f ( {x}_{0} ) + J \cdot Δx - m ) ‖}^{2} + \frac{1}{2} λ \cdot {ϕ}_{G} ( {W}_{x} \cdot ( {x}_{0} + Δ x ) ) . \qquad ( 14 )$$

Due to the non-squared regularization term, no closed-form solution exists and Δx is found through the Iterative Reweighting algorithm:

$$[ 0.5 {J}^{T} {W}_{d}^{T} {W}_{d} J + 0. 5 λ {W}_{x}^{T} {R}_{x} {W}_{x} ] Δ x = - 0.5 λ {W}_{x}^{T} {R}_{x} {W}_{x} {x}_{0} - 0.5 {J}^{T} {W}_{d}^{T} {W}_{d} ( f ( {x}_{0} ) - m ) \qquad ( 15 )$$

where Rₓ is a diagonal matrix with entries R_{x,ii}=φ_{G}′(yᵢ)/yᵢ with y=x₀+Δx. The reweighting is started with the unit matrix Rₓ=I, the computed model change Δx updates Rₓ and Eqn. 15 is solved iteratively until Δx converges.

In some embodiments, if the processor 30 determines that Δ“x” does not reduce the cost function because of response nonlinearity, i.e., x₀+Δx is outside of the validity of the linearization, the processor 30 may employ a line search algorithm, thus causing the processor 30 to probe x₀+δΔx, iteratively reducing δ until a cost function is reduced. The processor 30 may repeat the linearization process until convergence.

The regularization constant λ balances the data misfit and the regularization terms of the cost function, and ensuring finding the model with the least variation that explains the measurements. In some embodiments, the adaptive regularization algorithm A is not predefined but the processor 30 may estimate the regularization constant in each inversion iteration via Occam's method or any ad-hoc cost function reducing parameter search methods. Once the error term is linearized, the processor 30 may determine a cost function update Δx for different values of λ. The optimal choice of λ is determined by the Δx that reduces the actual error term the most:

$${λ}_{c} = {min}_{λ} [ {‖ {W}_{d} \cdot ( f ( {x}_{0} + Δ x ( λ ) ) - m ) ‖}^{2} ] \qquad ( 16 )$$

Upon failure of the Occam search, λ_{c} is found using an efficient line-search algorithm, which requires only a few additional forward model calls. This typically results in reduced number of iterations compared to using a heuristically found regularization constant λ, therefore reducing the number of costly computations of the Jacobian matrix J.

For 3D imaging inversion, it is not practical to solve for Δx of (eqn. 15) directly, even assembly of the full Hessian matrix H=0.5J^{T}W_{d}^{T}W_{d}J+0.5λWₓ^{T}RₓWₓ is not feasible on a standard computer (e.g., 32 GB of RAM). Instead, the processor 30 may utilize an iterative solver described in the next section to compute Δx.

### Iterative Linear Solver for Gradient Evaluation

Iterative solvers of the resulting normal equation HΔx=−g may not utilize the full matrix Hessian matrix H. The matrix H can be passed as a function handle because only multiplications of H with a vector may be computed internally. In the case of the Gauss-Newton inversion, this product can be efficiently computed with two multiplications of the Jacobian matrix times a vector.

In some embodiments, the processor 30 may select the Generalized Minimum Residual solver. In addition, it may be desirable to precondition iterative solvers to converge in a reasonable time (e.g., the processor 30 may use a preconditioner in an iterative solver). The following preconditioners can be used:
1. Jacobi preconditioning, using the diagonal elements of H.
2. The diagonal elements of 0.5J^{T}W_{d}^{T}W_{d}J plus the full regularization term 0.5λWₓ^{T}RₓWₓ.
3. Same as 2, combined with the incomplete LU factorization.

Using approach 3, the processor 30 may utilize two iterative solvers to compute the model update Δx so it is presently recognized that it may be advantageous that their convergence criteria and thresholds are correctly set to produce an accurate model update in reasonable time. Convergence of the outer Iterative Reweighting is determined by ∥Δxₖ₊₁−Δxₖ∥/∥x∥<0.01 (the elements of x are log₁₀ (Rh) and log₁₀ (Rv) of all voxels). This relatively high threshold may provide a fast convergence of the reweighting within only a few iterations, especially for the last Gauss-Newton iterations before termination. At the final iterations of the Gauss-Newton algorithm, often no reweighting is required at all, effectively producing L2-norm steps. Hence major resistivity variations are imaged sharply but variations with little sensitivity may be imaged with smooth resistivity transitions. The convergence threshold for the Ax=b solver is set to ∥b−Ax∥/J∥b∥<0.0002, (e.g., much lower than the IRW residual) which may ensure that reweighting converges.

The Jacobian matrix is passed to the Gauss-Newton inversion in single precision and immediately adjusted with the error weights so the Jacobian matrix may not be duplicated in the memory when passed to sub-functions. In addition, a 4× speedup is achieved by removing Jacobian entries using relative threshold (e.g., of 0.0001, which may be inspired by 0.0002 relative residual convergence of Ax=b solve) which may provide a 70-80% compression. In some embodiments, the relative threshold may be between about 1/10 to ½ of the residual convergence. For example, the relative threshold may be about 1/10, about ⅓, or about ½ of the upper level convergence stopping criteria.

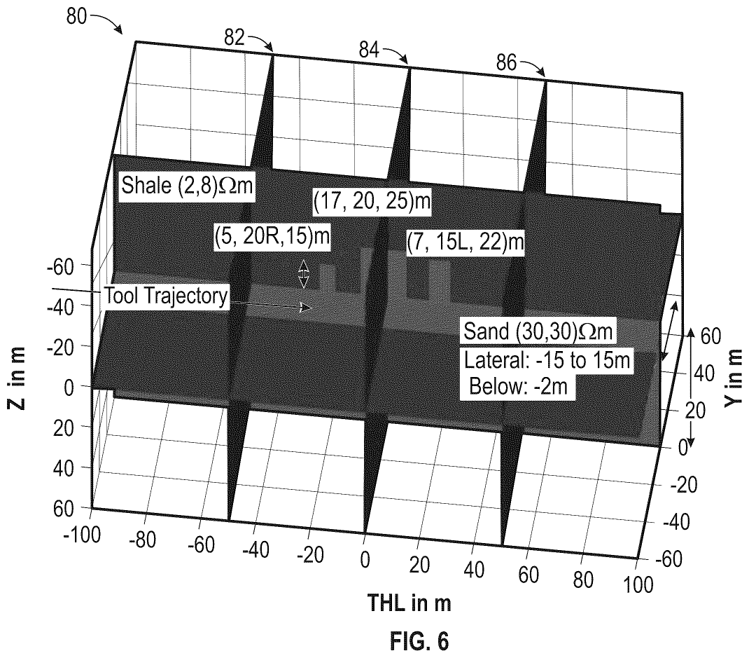

For example, the 3D voxel-based inversion workflow is tested on a newly generated synthetic data from three-fingers sand injectite example. FIG. 6 illustrates the 3D Sand Injectites visualization 80 (Rh=30 Ωm, anis=1) model with three fingers 82, 84, 86 that are about 5, 17 and 7 m long along THL; 15, 25 and 22 m high and ([5-15], right shifted) 20, ([−10 10], centered) 20 and ([−5 10], left shifted) 15 m thick in transverse direction, respectively. The tool is moving along THL 2 m below the main sand body which 30 m thick in the transverse direction and has horizontal and vertical resistivity of 30 Ωnm surrounded by shale (Rh=2 Ωm, Rv=8 Ωm) on all sides.

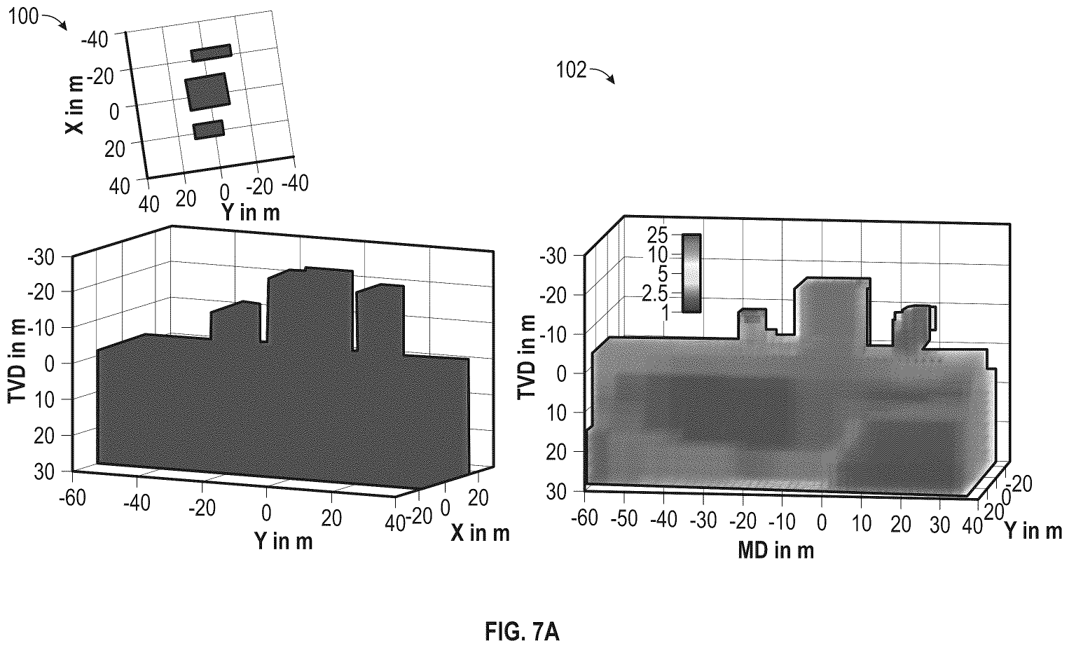

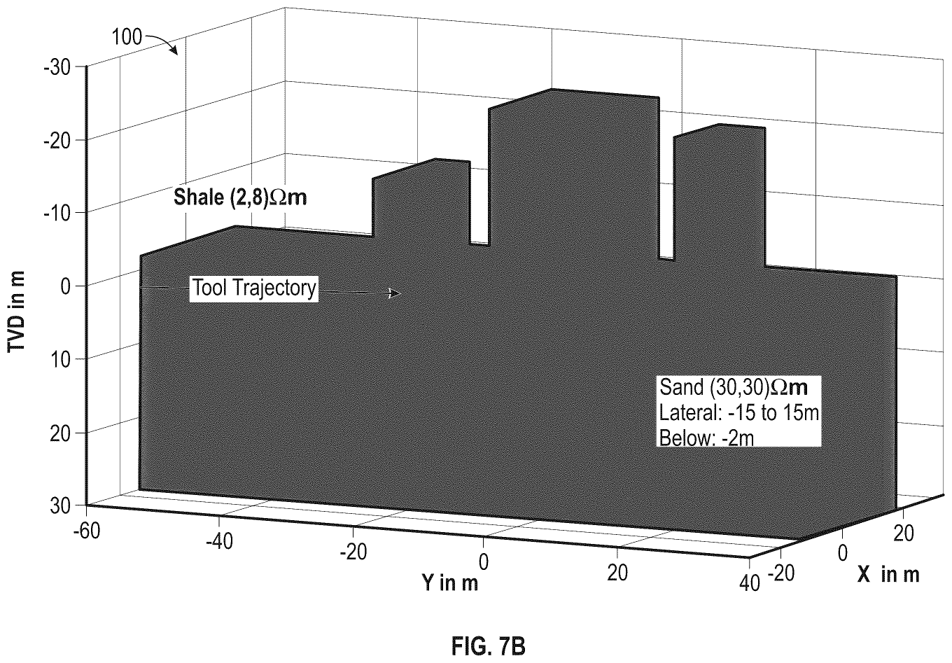

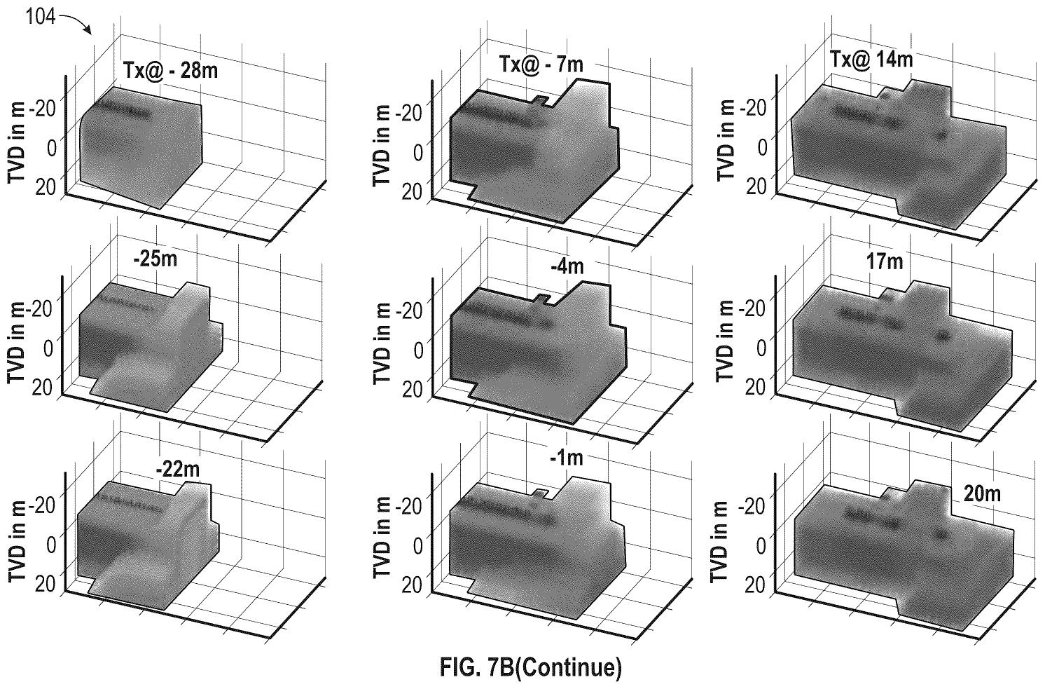

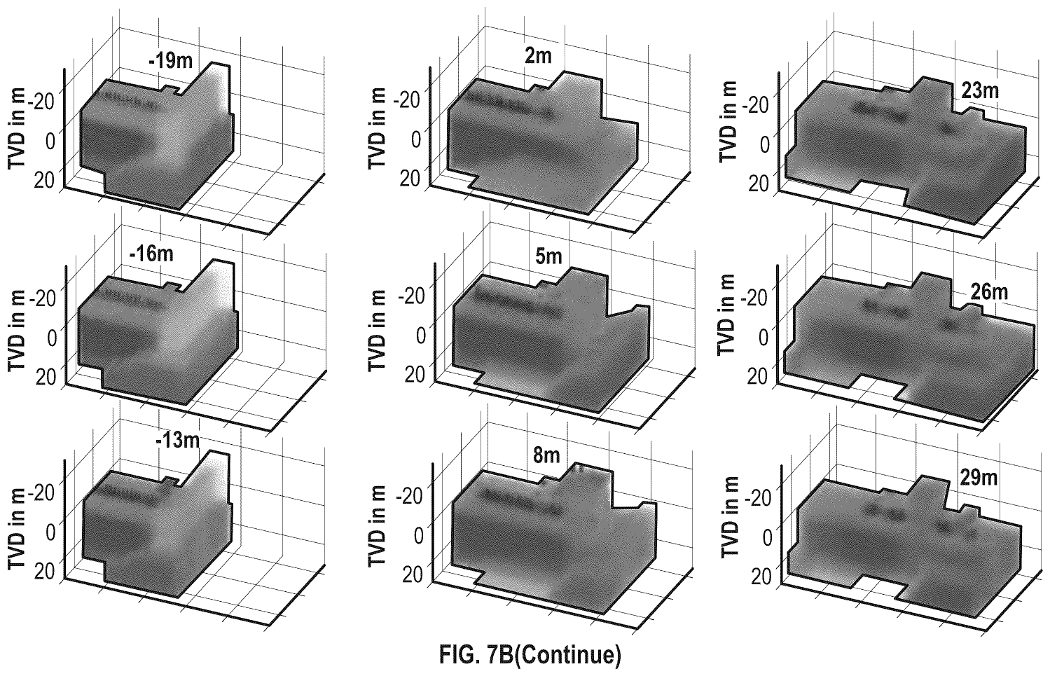

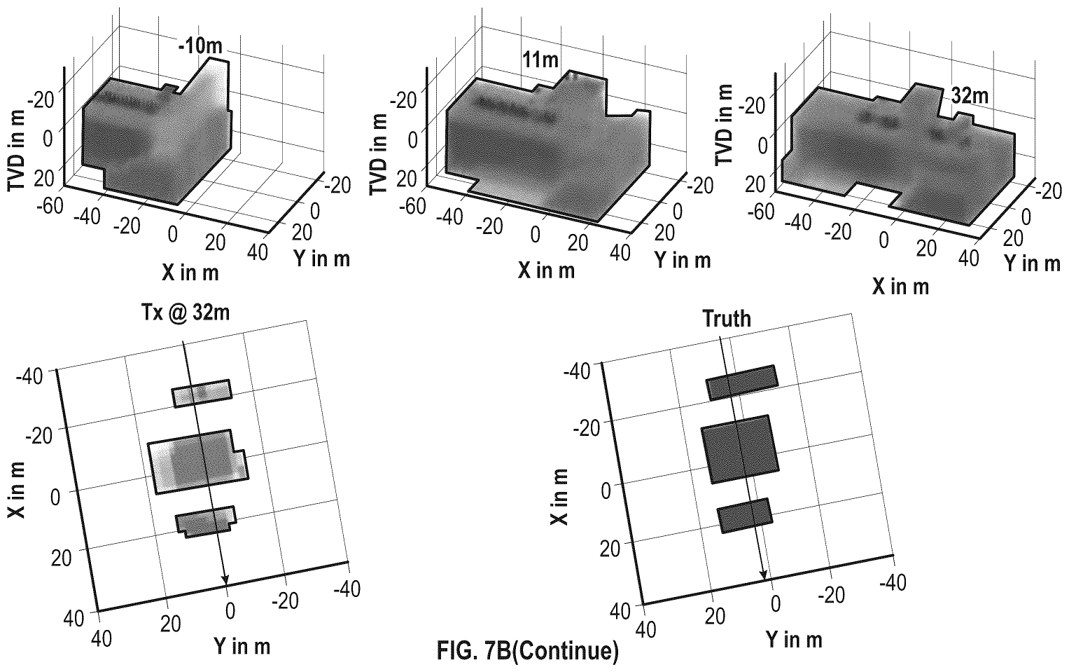

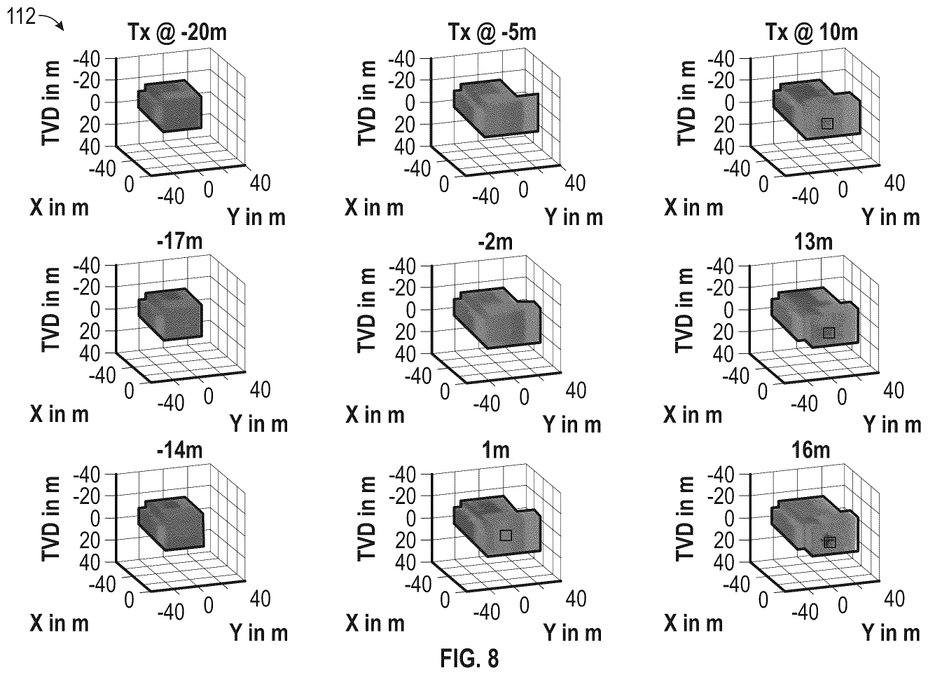

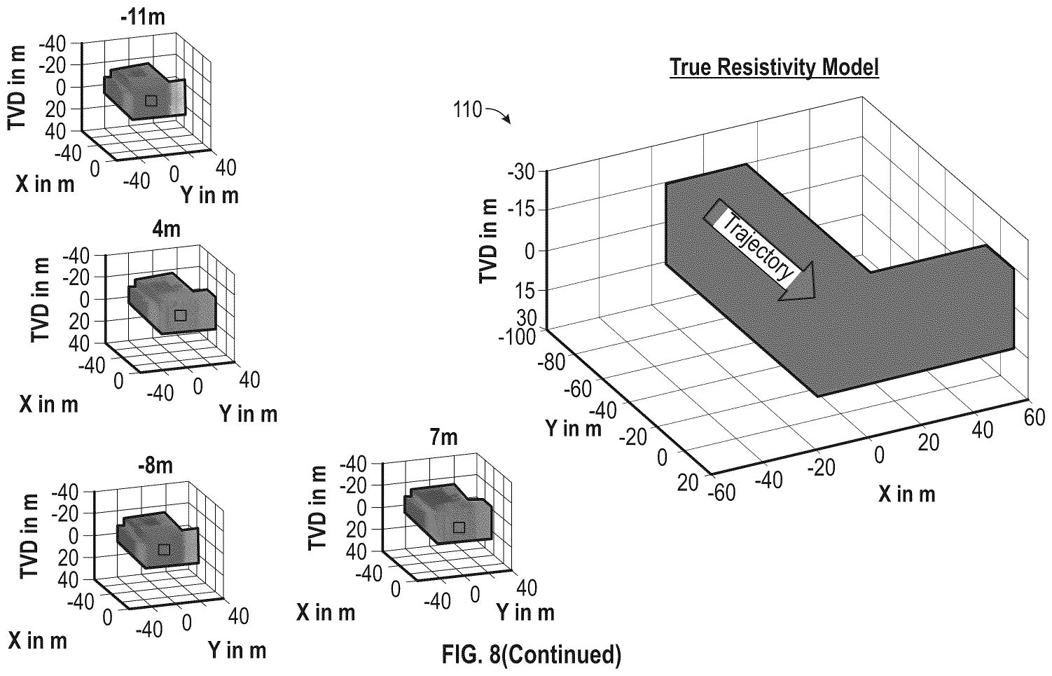

FIG. 7A illustrates a visualization 100 of a 3D resistivity model and a visualization 102 of the inversion results as the tool moves from −28 m to 32 m (transmitter location). In some embodiments, the processor 30 may utilize equal L1-regularization along all dimensions (e.g., of the discretized volume of the geological formation 14) and using previous inversion results are prior for the current tool position to perform the 3D inversion. It is evident that consistent results are obtained for all tool positions, as shown in FIG. 7B. FIG. 7B shows a series of inversion results 104 at different tool positions (e.g., ‘Tx @y, where y is a distance represented in meters (m)). The last inversion result and its top view illustrates decent resolution power and accuracy of the inversion scheme, especially the faithful reconstruction of the location and shapes of the three sand fingers. FIG. 8 shows another example of a 3D voxel-based inversion flow using a handbrake turn model. In particular, FIG. 8 shows the true resistivity model 110 and inversion results 112.

As described herein, Tx-based referencing provides look-ahead capabilities ahead of the drilling bit in real-time. To illustrate this, FIG. 9 shows a visualization 120 of a 3D voxel-based inversion output of a conductive region 122. The visualization 120 includes a tool sensing volume 124 (e.g., the area bound by dashed lines). As shown, the conductive region 124 is visible approximately 7 m before the conductive region 122 is within the tool sensing volume 124. As the tool approaches the conductive region 122, the conductive region is confirmed.

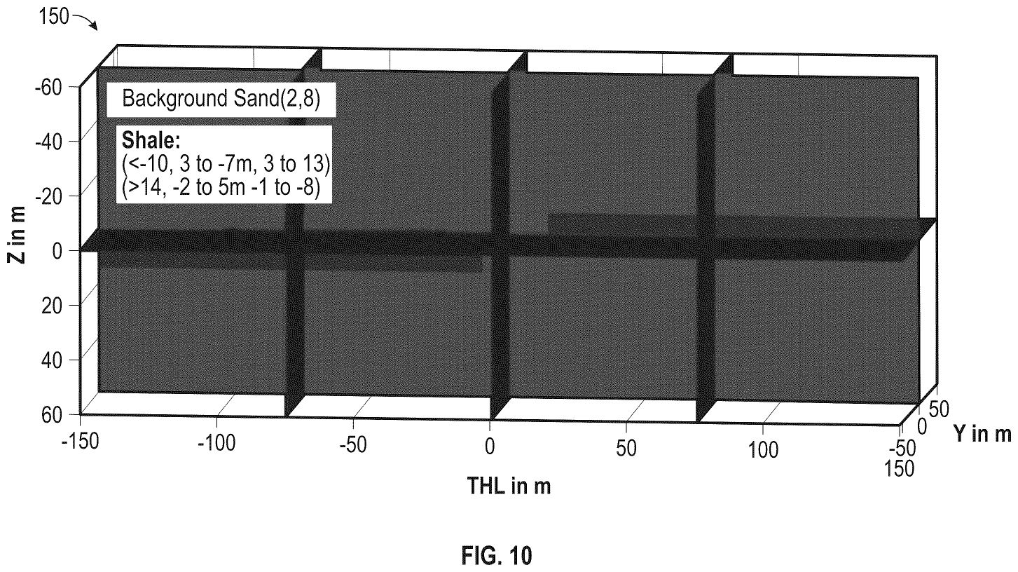

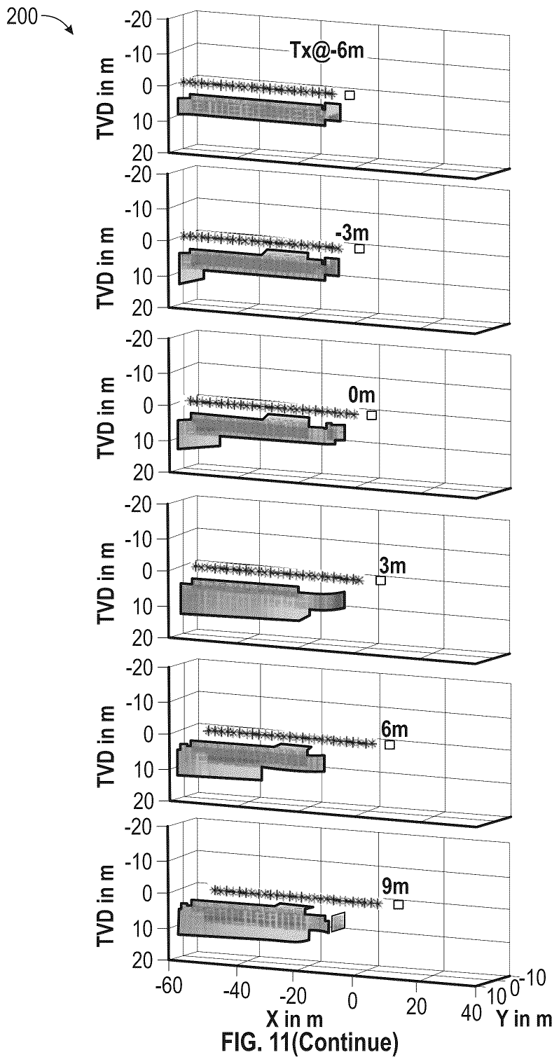

In another example, the 3D voxel-based inversion workflow is tested on a newly generated synthetic data from ‘Shale Avoidance’ example. FIG. 10 illustrates a visualization 150 of the 3D model with the tool moving in a sand (Rh=30 Ωm, anis=1) background having one thin shale (Rh=2 Ωm, Rv=8 Ωm) region 3 m below the trajectory and another shale region 2 m above the trajectory. The two regions are 10 m and 7 m high while 10 m ([3−7], right shifted) and 7 m ([−1−8], left shifted) thick in transverse direction, respectively.

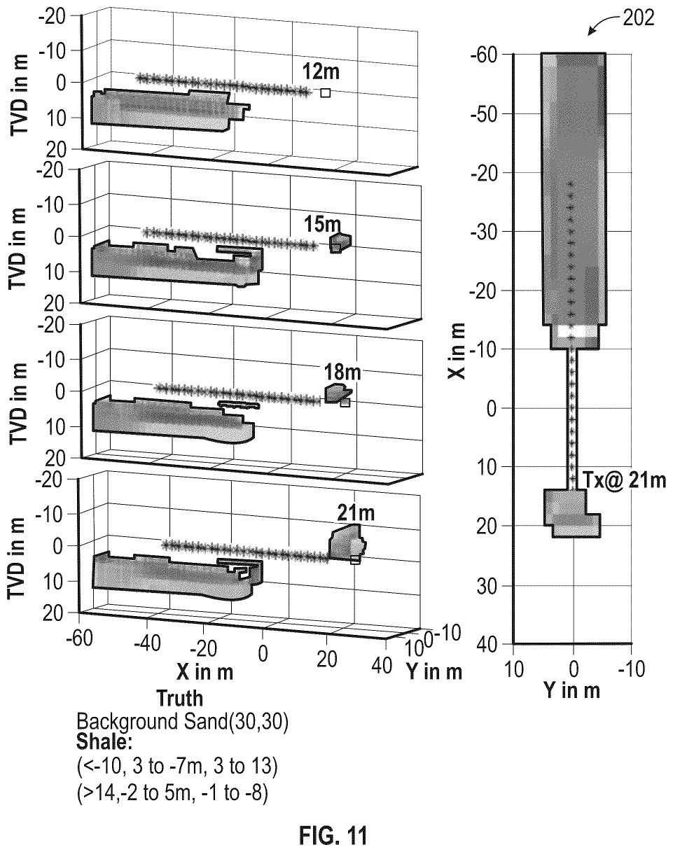

FIG. 11 illustrates a first visualization 200 depicting the inversion results as the tool moves from −24 m to 21 m (transmitter location). In some embodiments, the processor 30 may perform the 3D inversion using equal L1-regularization along all dimensions and using previous inversion results as prior for the current tool position. It is evident that consistent results are obtained for all tool positions. FIG. 11 also illustrates a second visualization 202 that depicts the last inversion result and its top view shows decent resolution power and accuracy of the inversion scheme, especially the faithful reconstruction of the location and shapes of the thin shale bodies in the sand background.

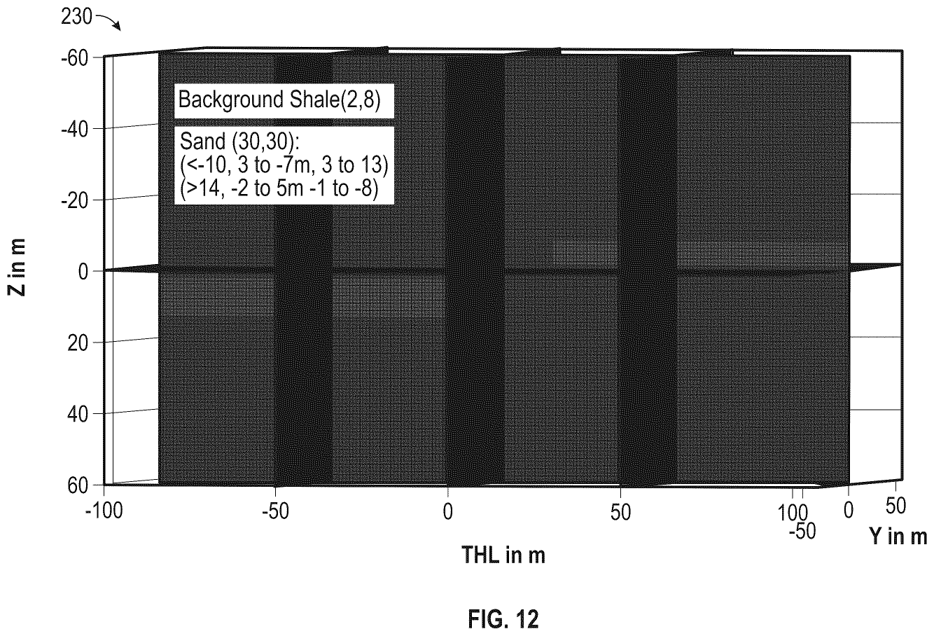

In another example, the 3D voxel-based inversion workflow is tested on a newly generated synthetic data from ‘Residual Oil’ example. For this conductive scenario, the processor 30 may run independent Occams to get meaningful results than using previous inversion step results as initial guess. FIG. 12 illustrates a visualization 230 of the 3D model with the tool moving in a shale (Rh=2 Ωm, Rv=8 Ωm) background having one thin oil-bearing sand (Rh=30 Ωm, anis=1) region 3 m below the trajectory and another shale region 2 m above the trajectory. The two regions are 10 m and 7 m high while 10 m ([3 −7], right shifted) and 7 m ([−1 −8], left shifted) thick in transverse direction, respectively.

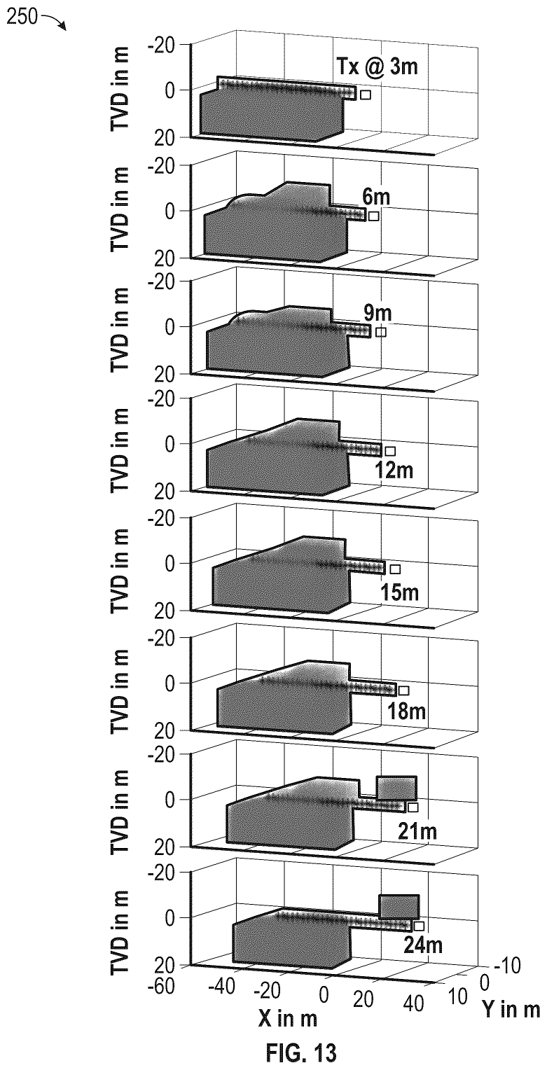

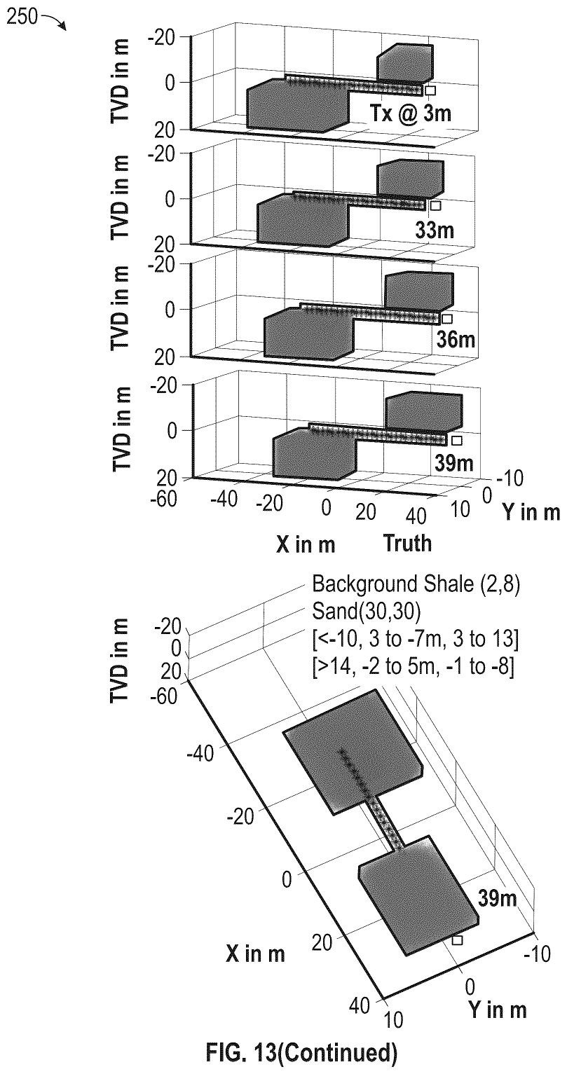

The inversion results are also viewed in the inverse color map, as shown in the visualization 250 of FIG. 13, as the tool moves from −24 m to 48 m (transmitter location). The inversion uses equal L1-regularization along all dimensions but due to the conductive nature of the background independent inversion give improved results. Consistent results are obtained for all tool positions. The last inversion result and its top view give correct results for near-to-the-tool edge of the thin sand-body but the farther edge is over-estimated.

The specific embodiments described above have been illustrated by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. A method, comprising:
receiving ultra-deep azimuthal resistivity (UDAR) measurements from a downhole tool within a geological formation;
determining a data processing window based on a relative location of a transmitter of the downhole tool with respect to a location of one or more components of the downhole tool;
performing a three-dimensional (3D) inversion of the UDAR measurements based on the relative location of the transmitter; and
generating an anisotropic resistivity distribution output based on the 3D inversion.

2. The method of claim 1, further comprising determining a formation dip based on the anisotropic resistivity distribution output.

3. The method of claim 1, wherein the anisotropic resistivity distribution output comprises a model of the formation.

4. The method of claim 1, wherein the anisotropic resistivity distribution output comprises saturation of a volume within the geological formation.

5. The method of claim 1, wherein the 3D inversion is a voxel-based inversion.

6. The method of claim 1, wherein generating the anisotropic resistivity distribution output comprises updating a visualization of the geological formation in substantially real-time.

7. The method of claim 1, wherein performing the 3D inversion comprises utilizing a full 3D EM solver, at each iteration of the inversion process, to generate tool responses until a substantial match with the acquired electromagnetic measurements is achieved.

8. The method of claim 1, wherein performing the three-dimensional (3D) inversion of the UDAR measurements based on the relative location of the transmitter comprises utilizing an iterative solver.

9. The method of claim 1, wherein the data processing window is at least 1.5 times a receiver antenna spacing of the downhole tool.

10. The method of claim 1, wherein performing the 3D inversion comprises determining a regularization constant in each iteration of the 3D inversion using Occam's method or any ad-hoc cost function reducing parameter search methods.

11. A tangible, non-transitory, computer-readable medium configured to store instructions executable by processing circuitry, wherein the instructions comprise instructions to cause the processing circuitry to perform operations comprising:
receiving ultra-deep azimuthal resistivity (UDAR) measurements from a downhole tool within a geological formation;
determining a data processing window based on a relative location of a transmitter of the downhole tool with respect to a location of one or more components of the downhole tool;
performing a three-dimensional (3D) inversion of the UDAR measurements based on the relative location of the transmitter; and
generating an anisotropic resistivity distribution output based on the 3D inversion.

12. The computer-readable medium of claim 10, wherein the processing circuitry is configured to perform the 3D inversion by utilizing a Jacobi preconditioning.

13. The computer-readable medium of claim 10, wherein the data processing window is at least 1.5 times a receiver antenna spacing.

14. The computer-readable medium of claim 10, wherein the processing circuitry is configured to perform the 3D inversion by utilizing equal L1-regularization along all dimensions of the volume and using previous inversion results for a current tool position of the downhole tool.

15. The computer-readable medium of claim 10, wherein performing the 3D inversion comprises applying a Jacobian matrix applied to the electromagnetic measurements.

16. The computer-readable medium of claim 10, wherein performing the 3D inversion comprises utilizing electromagnetic measurements acquired every 1/10 or less of a distance between a transmitter and a receiver of the downhole tool.

17. A system, comprising:
an electromagnetic downhole tool configured to generate electromagnetic measurements associated with a volume within a geological formation;
a data processing system communicatively coupled to the electromagnetic downhole tool, wherein the data processing system comprises one or more processors, wherein the data processing system is configured to:
receive ultra-deep azimuthal resistivity (UDAR) measurements from a downhole tool within a geological formation;
determine a data processing window based on a relative location of a transmitter of the downhole tool with respect to a location of one or more components of the downhole tool;
perform a three-dimensional (3D) inversion of the UDAR measurements based on the relative location of the transmitter; and
generate an anisotropic resistivity distribution output based on the 3D inversion.

18. The system of claim 16, wherein the data processing system is configured to display a visualization of the volume of the geological formation based on the anisotropic resistivity distribution output.

19. The system of claim 16, wherein the data processing system is configured to perform the 3D inversion by utilizing a full 3D EM solver to substantially match the electromagnetic measurements.

20. The system of claim 16, wherein the anisotropic resistivity output comprises an updated 3D voxel-based model of a volume of the geological formation.

21. The system of claim 16, wherein the data processing system is configured to perform the 3D inversion by using an iterative solver.
